(19) United States
(12) Patent Application Publication
(10) Pub. No.: US 2006/0181089 A1
(43) Pub. Date: Aug. 17, 2006

(54) Beam with an over-moulded insert

(75) Inventors: Gerald Andre, Ambrieu en Bugey (FR); Daniel Hegelen, Meximieux (FR); Jean-Pierre Roux, Pommiers (FR); Laurent Rocheblave, Villeurbanne (FR)

Correspondence Address: EPSTEIN DRANGEL BAZERMAN & JAMES, LLP, 60 EAST 42ND STREET, SUITE 820, NEW YORK, NY, 10165, US

(73) Assignee: Compagnie Plastic Omnium

(21) Appl. No.: 10/547,610

(22) PCT Filed: Apr. 22, 2005
(86) PCT No.: PCT/FR05/01006

§ 371 Date: Apr. 25, 2006

(30) Foreign Application Priority Data
Apr. 23, 2004 (FR) 0404356

(51) Int. Cl. B60R 19/03

(52) U.S. Cl. 293/120

(57) ABSTRACT

The invention relates to an impact beam comprising a metal crosspiece and reinforcement ribs made of a plastics material and overmolded onto the metal crosspiece.

The present invention relates to an impact beam for a motor vehicle.

### BACKGROUND OF THE INVENTION

Motor vehicle impact beams are known that are crosspieces of the type serving to provide protection in the event that a vehicle is subjected to an impact against an obstacle.

In general, such an impact beam is suitable for absorbing the energy from an impact even when said beam is subjected to a large amount of deformation.

Two types of protection are expected from such beams.

When the impact takes place against a stationary object and at a height normally corresponding to an impact between the bumpers of two vehicles, a single, high impact beam, placed at the same height as, and continuing on from, the side rails of the vehicle, procures protection for the parts of the vehicle situated behind it, and absorbs as much energy from the impact as possible.

In contrast, when the impact takes place against the leg of a pedestrian, a second impact beam at low height serves to prevent the leg of the pedestrian from deforming to the extent of giving rise to serious injury, in particular at the knee.

### OBJECTS AND SUMMARY OF THE INVENTION

The present invention relates to all impact beams, both high beams and low beams.

In this field, it is common for beam structures to be used that comprise a rigid crosspiece, often made of metal, lined with an absorber, often made of a plastics material, and more generally a foam. The rigid crosspiece provides bending strength and offers a bearing surface over the entire width of the vehicle, whereby the absorber can work essentially in compression, behind the skin of the bumper, for the purpose of reducing the quantity of energy transmitted to the remainder of the vehicle.

But such structures are clearly made up by uniting two distinct parts, mounted one on the other, or coming into contact with each other in the event of an impact.

In addition, outside the field of motor vehicle impact beams, it is known that hybrid crosspieces can be implemented by overmolding reinforcement ribs made of a plastics material over metal shaped-section members, so as to make advantageous use of the second moment of area of the resulting assembly. Document EP 0 370 342 shows an example of such a crosspiece.

Surprisingly, such structures have not yet been applied to impact beams, probably because of the sudden stresses to which impact beams are subjected, suggesting different behavior that is not compatible with hybrid-structure parts.

In addition, an impact beam must absorb the energy from an impact even when it is being subjected to considerable deformation, which would not seem to be possible for a hybrid crosspiece as known from the state of the art. Indeed, For such a crosspiece, the plastics material is applied to the metal shaped-section member at isolated coupling points only, those points breaking easily, in particular when subjected to large amounts of deformation.

However, by performing simulations and full-scale testing, the inventors of the present invention have observed that, in the event of sudden impacts, impact beams have behavior that is compatible with parts that are of hybrid structure, and that, in addition, hybrid structures offer better compactness, and a considerable saving in weight for equivalent behavior.

An object of the present invention is thus to provide a novel impact beam structure that offers the advantage of being simpler to make and to mount on a vehicle, while being more compact, lighter in weight and less expensive than a conventional impact beam.

The present invention provides an impact beam comprising a metal crosspiece, said impact beam further comprising reinforcement ribs made of a plastics material and overmolded onto the metal crosspiece.

In the sense of the present invention, “reinforcement ribs” means ribs that are adapted to improving the ability of the cross-piece to retain its shape, so as to preserve its second moment of area. Such ribs can also be termed “stabilizer ribs”.

In a particular embodiment of the invention, the crosspiece is provided with at least one window defined by an edge, and the plastics material overmolded onto the crosspiece for forming the reinforcement ribs covers said edge at least in part, so that the plastics material of which the ribs are made is mechanically fastened to the metal crosspiece.

In this embodiment, the plastics material does not fill the window in the crosspiece, and said window remains an unobstructed opening between the two sides of the wall in which it is cut out.

In advantageous variants of this embodiment, the edge of the window has a cutout configuration that is scalloped, or of fractal type, or of Greek key pattern shape, or shaped like the joins between pieces of jig-saw puzzle, so as to improve the mechanical fastening of the plastics material to the metal crosspiece, in particular by guaranteeing effective fastening even in the event of multidirectional stress.

In another advantageous variant, the window is provided with battens optionally constituting shapes that the plastics material can coat in order to fasten said material to the metal crosspiece in addition to said material coating the edge of the window.

The battens are especially useful in maintaining the stiffness of the crosspiece so as to prevent the presence of the windows from excessively weakening said crosspiece.

Advantageously, the crossings between battens have only two or three branches, so that they form merely L-shapes or T-shapes, thereby improving the stiffness of the crosspiece, and when the window has four branches, the opposite battens are offset so that the four branches do not converge at the same point.

In a particular embodiment of the invention, one or more windows are dimensioned and positioned in the crosspiece so as to enable the plastics material injected on one side of the crosspiece to pass through to the other side of the crosspiece and to form both the ribs and additional ribs constituting an energy absorber.

Through successive testing, and while taking account of the shape of the impact beam, the person skilled in the art is capable of disposing and dimensioning the windows so that injection molding leads to the reinforcement ribs being formed on one side of the crosspiece and to the energy absorber being formed on the other side of the crosspiece.

This embodiment of a beam having reinforcement ribs on either side of the crosspiece, but obtained by overmolding in a mold in which the plastics material is fed in on one side of the mold cavity only, makes it possible to keep down the cost of the mold, and thus to reduce the cost of the part considerably.

In addition, since the additional ribs form an energy absorber, the energy absorber and the metal crosspiece together form one piece only, thereby facilitating mounting them on the motor vehicle.

Optionally, the impact beam of the invention includes energy absorber boxes.

Preferably, the energy absorber boxes are made of a material selected from steel, aluminum, and plastic.

Preferably, the crosspiece is made of a material selected from sheet steel, sheet aluminum, and Twintex™ woven fabric.

Finally, in advantageous manner, the reinforcement ribs are made of a material selected from a thermoplastic material filled with talc, filled with glass fiber, or not filled, a thermosetting material and a Hybrid Thermo-Plastic Composite (HTPC) material.

### BRIEF DESCRIPTION OF THE DRAWINGS

The invention will be better understood on reading the following description given merely by way of example and with reference to the accompanying drawings, in which:

FIG. 1 is a perspective view of an embodiment of an impact beam of the invention;

FIG. 2 is a perspective view of the metal crosspiece of the impact beam of FIG. 1;

FIG. 3 is a section view on III-III of FIG. 1;

FIG. 4 is a close-up view looking along arrow IV, showing the crosspiece of FIG. 2;

FIG. 5 is a perspective view of another embodiment of an impact beam of the invention;

FIG. 6 is a view similar to the FIG. 3 view, showing another embodiment of an impact beam of the invention;

FIG. 7 is a close-up view of a portion of a crosspiece of another impact beam; and

FIG. 8 is a face view of another crosspiece of another impact beam.

### MORE DETAILED DESCRIPTION

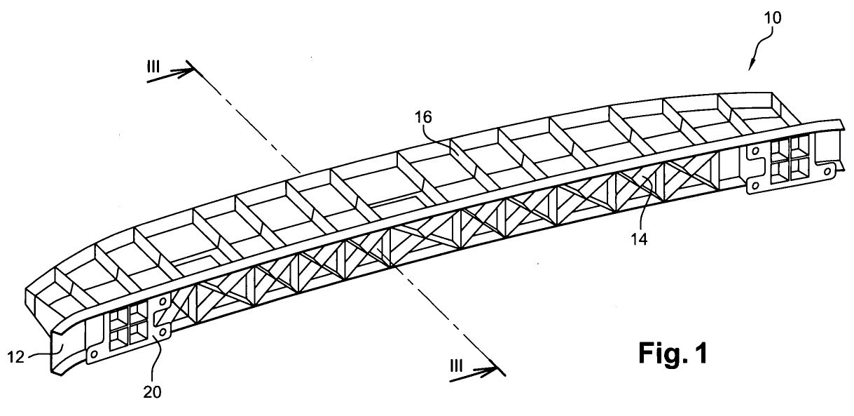

The impact beam of FIG. 1, designated by overall reference 10, comprises firstly a U-shaped-section metal crosspiece 12 also referred to as an “insert” and constituted by a bottom wall with two flanges, and secondly an array of internal ribs 14, and an array of external ribs 16.

The function of the array of internal ribs 14 is to stabilize the metal crosspiece 12 by preserving its U-shaped section, which ensures it has an optimal moment of inertia.

Preserving the second moment of area of the crosspiece 12 requires not only the presence of an array of internal ribs 14, but also good mechanical fastening for fastening said array of internal ribs 14 to the crosspiece 12, which is achieved by the ribs covering window edges 18 as described below.

At either end of the array of internal ribs 14, plates 20 for fastening the beam 10 to rails (not shown) of the vehicle are integrally molded with the ribs of the array of internal ribs 14.

The internal ribs 14 lie entirely within the cross-section of the insert 12, whereas the plates 20 project towards the inside of the vehicle, i.e. backwards relative to FIG. 1.

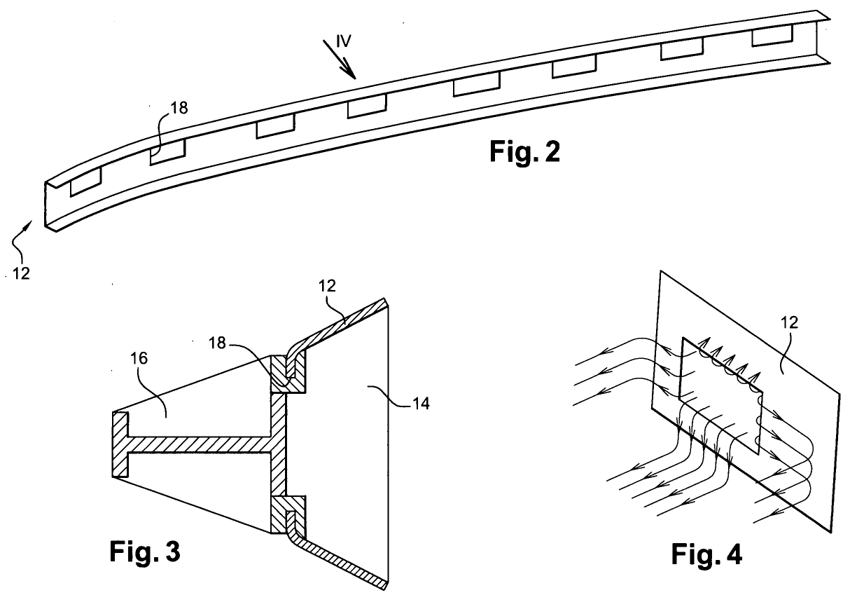

FIG. 2 shows eight windows 18 which pass through the bottom wall of the crosspiece 12 and which are distributed over its entire length.

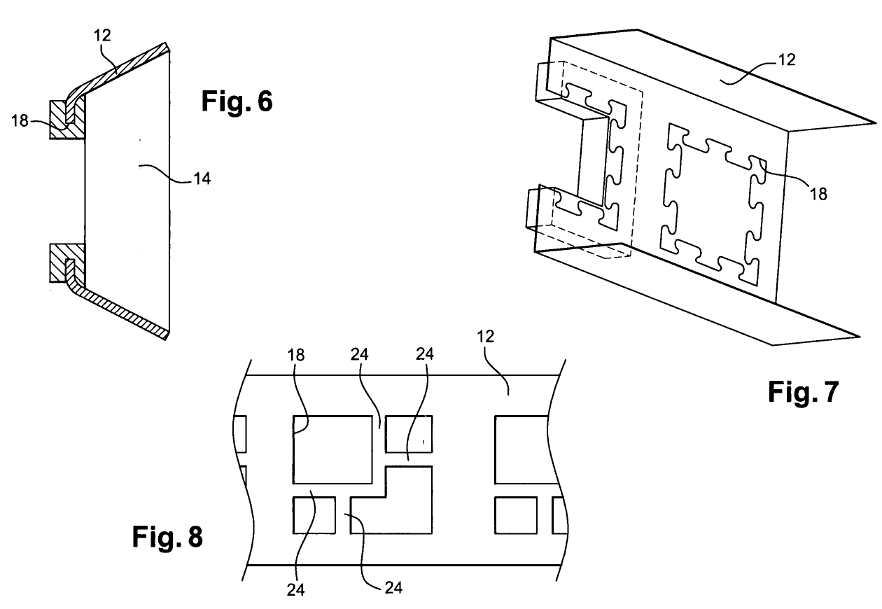

As shown in particular in FIG. 6, the plastics material overmolded onto the crosspiece 12 for forming the internal ribs 14 passes through the bottom wall of the crosspiece 12 and out onto its opposite face by passing over and covering the edge of each window 18. This covering of the edges of the windows 18 fastens the array of internal ribs 14 to the crosspiece 12.

It should be noted that such mechanical fastening achieved by covering the edges of the windows 18 makes it possible for the plastics material to be held firmly on the metal crosspiece 12 even in the event of large amounts of deformation.

In addition, since the plastics material extends all the way around the windows 18 for fastening purposes, the resulting impact beam 10 does not have any weak points, and has stiffness that is substantially uniform over the entire length of the part. Thus, an impact is treated similarly by the impact beam 10 regardless of which zone of the beam 10 is subjected to the impact.

Naturally, other mechanical fastening means can be implemented on their own or in combination with the covering of edges that is described above.

The outside longitudinal edges of the crosspiece 12 are preferably also covered in plastics material, in particular for the purpose of protecting said longitudinal edges from corrosion, in addition to fastening the plastics material to the crosspiece 12.

In a particular embodiment of the invention, the windows 18 do not only provide edges for covering: they also allow the plastics material to pass through to the other side of the crosspiece 12 and propagate forwards in order to form the ribs of the array of external ribs 16 constituting an energy absorber.

In a variant, it might be preferred to mold the ribs of the array of external ribs 16 first, so that the plastics material passes through the windows 18 to form the array of internal ribs 14.

The resulting impact beam 10 is shown in section at a window 18, in FIG. 3.

In both cases, the plastics material extends without any interruption through the insert 12. The energy absorber 16 is then held securely against the crosspiece 12.

It should also be noted that the energy absorber 16, as held against the crosspiece 12 in this way, is more effective than a conventional energy absorber. Indeed, this energy absorber 16 works better when compressed than a conventional energy absorber, since such an energy absorber comes into contact with a crosspiece during the impact and can, in particular slide against said crosspiece. Thus, since the absorber 16 is more effective, it is possible to reduce the quantity of material forming it, and thus to reduce the weight of the impact beam 10.

The dimensioning of the windows 18 and their distribution should be determined by the person skilled in the art as a function of the overall shape of the impact beam 19, so that the flow of plastics material passing through the windows 18 is sufficient.

The flow of plastics material passing through a window 18 is shown in FIG. 4.

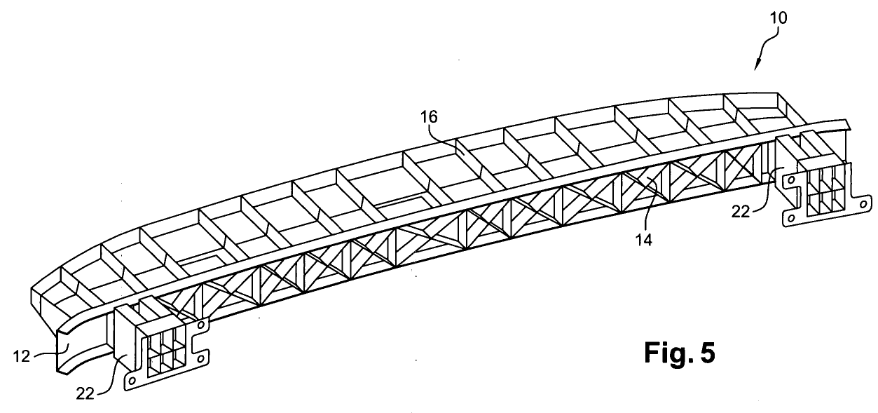

In FIGS. 5 to 8, elements analogous to the elements in the preceding figures are designated by identical references.

FIG. 5 shows another impact beam 10 which, in addition to the internal ribs 14 and to the external ribs 16, also has energy absorber boxes that are also integrally molded with the set of ribs 14, 16 covering the cross-piece 12.

FIG. 7 shows a particular configuration of a window 18 whose edge is shaped like the joins between pieces of jig-saw puzzle. By means of this particular shape of the edge of the window 18, the plastics material covering the edge of the window 18 is fastened more effectively to the crosspiece 12, even in the event of multi-directional stresses.

In the embodiment shown in FIG. 8, each window 18 has four battens 24 that cross and form cross-work pieces in the central region of the window 18. The function of the battens 24 is to reinforce the crosspiece 12 in spite of the presence of the windows 18. In order to improve this reinforcing effect further, two opposite battens 24 are offset relative to one another, so that the four battens 4 do not cross over at a single point in the window 18. On the contrary, the crossings are limited to the battens 24 meeting in pairs to form T-junctions or L-junctions with three or two branches respectively.

As explained above, covering the edges of the window 18 mechanically fastens the ribs 14 to the crosspiece 12, but the battens 24 can themselves also be coated with a plastics material for the purpose of reinforcing the fastening. It should be noted that such fastening is effective even in the event of multidirectional stress.

Naturally, the above-described embodiments are in no way limiting, and any desirable modification can be made to them without going beyond the ambit of the invention.

What is claimed is:

1. An impact beam comprising a metal crosspiece, said impact beam further comprising reinforcement ribs made of a plastics material and overmolded onto the metal crosspiece.

2. An impact beam according to claim 1, in which the crosspiece is provided with at least one window defined by an edge, and the plastics material overmolded onto the crosspiece for forming the reinforcement ribs covers said edge at least in part, so that the plastics material of which the ribs are made is mechanically fastened to the metal crosspiece.

3. An impact beam according to claim 2, in which the edge of the window has a cutout configuration that is scalloped, or of fractal type, or of Greek key pattern shape, or shaped like the joins between pieces of jig-saw puzzle, so as to improve the mechanical fastening of the plastics material to the metal crosspiece.

4. An impact beam according to claim 1, in which the window is provided with battens optionally constituting shapes that the plastics material can coat in order to fasten said material to the metal crosspiece in addition to said material coating the edge of the window.

5. An impact beam according to claim 4, in which the crossings between battens have only two or three branches, so that they form merely L-shapes or T-shapes.

6. An impact beam according to claim 1, in which one or more windows are dimensioned and positioned in the crosspiece so as to enable the plastics material injected on one side of the crosspiece to pass through to the other side of the crosspiece and to form both the ribs and additional ribs constituting an energy absorber.

7. An impact beam according to claim 1, including energy absorber boxes.

8. An impact beam according to claim 7, in which the energy absorber boxes are made of a material selected from steel, aluminum, and plastic.

9. An impact beam according to claim 1, in which the crosspiece is made of a material selected from sheet steel, sheet aluminum, and Twintex™ woven fabric.

10. An impact beam according to claim 1, in which the reinforcement ribs are made of a material selected from a thermoplastic material filled with talc, filled with glass fiber, or not filled, a thermosetting material, and a Hybrid Thermo-Plastic Composite material.
